(19) United States
(12) Patent Application Publication
(10) Pub. No.: US 2012/0298050 A1
(43) Pub. Date: Nov. 29, 2012

(54) COATED TENNIS BALL

(76) Inventor: Luke Merritt, Glenwood Springs, CO (US)

(21) Appl. No.: 13/117,595

(22) Filed: May 27, 2011

(51) Int. Cl. A01K 29/00; A61C 17/00; C11D 3/00

(52) U.S. Cl. 119/710; 510/160; 427/2.29

(57) ABSTRACT

Embodiments of the present application are directed at a tennis ball for cleaning canine teeth and fighting fetid breath. Embodiments describe a tennis ball coated with a cleaning mixture for cleaning canine teeth and fighting fetid breath. Embodiments herein also describe a process for creating the cleaning mixture and applying the cleaning mixture to the tennis ball. In another embodiment, the present disclosure relates to a dental spray solution. The dental spray solution may be sprayed directly onto the canines teeth, alleviating some of the concerns with respect to the chew toys discussed above. Once the dental spray solution is sprayed on the canine's teeth, the canine may be given a chew toy to assist with scrubbing off stains and tartar. Alternatively, the canine may be given the above disclosed tennis ball after the dental spray solution is applied to assist with scrubbing off stains and tartar.

### BACKGROUND

Proper oral hygiene in canines is a common concern for pet owners. Canines, like humans, suffer from high indices of periodontal disease. Maintaining good oral health in a canine can be a time consuming, costly, and frustrating experience. This can cause pet owners to neglect taking measures that ensure good oral health for their canines

Different approaches have been pursued to overcome the above difficulties associated with canine oral hygiene. One such approach impregnates a rawhide pet chew with various emulsions, surfactants, conditioners, and flavorants. The various items are released during mastication to help fight plaque from forming on the teeth of the canine and to fight fetid breath. Another approach impregnates a rope chew toy with fluoride particles to help prevent canine tooth decay. The fluoride particles are applied to the individual fibers of the rope before the rope toy is formed to provide desired fluoride distribution throughout the toy.

The above approaches, however, each encounter obstacles to achieving optimal oral health. These obstacles correlate to the structure of the chosen chew toy. A rawhide chew, for example, is typically chewed in a specific location using one side of the canine's mouth for an extended period of time. This pattern creates two obstacles to optimal oral health. First, chewing the rawhide in a specific location for an extended period depletes that location of impregnated components at a rate disproportionate to component depletion in the rest of the rawhide. Once the impregnated components are depleted, the specific location on the rawhide chew will no longer perform canine tooth cleaning functions. Yet, the pet owner, unaware of the rapidly depleted components, will continue to rely on the rawhide for canine oral hygiene enhancement. Second, canines tend to chew a rawhide solely on one side of the mouth. This unequal distribution causes the impregnated cleaning components to clean only one side of the mouth while the other side remains unaffected. Thus, such an unequal distribution results in only a partial enhancement of oral hygiene.

The rope toy faces further obstacles to achieving optimal canine oral health. A rope toy is typically used when a pet owner engages her canine in a tug-of-war game by pulling one end of the rope while the canine pulls the other end. The tug-of-war game is usually short lived as it requires physical exertion by the pet owner as well as by the canine. The transitory nature of canine rope use decreases the overall oral health benefits gained from a fluoride impregnated rope chew toy. Additionally, during tug-of-war, the canine typically grasps the rope with its front teeth leaving the back teeth untouched by the rope. Like with the rawhide, this grasp leads to unequal distribution of the impregnated fluoride and causes only a partial enhancement of oral hygiene. Also, like the rawhide, a pet owner has no way of knowing when the impregnated fluoride has been completely removed from the rope by the canine This unawareness could lead a pet owner to mistakenly rely on the depleted rope toy for oral hygiene—potentially damaging the oral health of the canine

A solution is needed for the above obstacles to canine oral health. Specifically, a need exists for a canine chew toy with oral cleaning capabilities that is both frequently used for extended durations of time and comes into contact with all teeth in the oral cavity. A need also exists for a canine chew toy in which the cleaning components are depleted from the different areas of the toy at proportionate rate. Furthermore, a need exists for an indication to a pet owner on the chew toy that the cleaning solution has been removed from the toy.

### SUMMARY

The present disclosure addresses the above obstacles to canine oral health. In one embodiment, the present disclosure relates to a tennis ball coated in a cleaning mixture. The cleaning mixture is formulated to clean the oral cavity of the canine, fight fetid breath, and attract the canine to the tennis ball. The coated tennis ball addresses the problems associated with previous methods chews. First, the tennis ball lends itself to long-term and frequent use as it requires little exertion by the pet owner and is often chewed by the canine without owner involvement. Second, the tennis ball overcomes partial tooth cleaning Both the size of the tennis ball and nature of playing “fetch” with a tennis ball cause the coated cleaning mixture to contact all teeth in the oral cavity resulting in a complete clean. Furthermore, the pressurized air within the tennis ball “pushes back” on the canine tooth when the canine bites into the ball causing the outer surface of the ball to more completely contact the canine tooth. Third, a canine comes into contact with many different areas of a tennis ball when playing fetch leading to more proportionate depletion of the cleaning mixture.

Additionally, the cleaning mixture coated on the tennis ball may be colored. This colored mixtures acts as an indicator, such that the color fades as the cleaning mixture is removed from the ball by the canine's saliva. When the cleaning mixture is no longer present on the ball, the ball returns to its natural color, indicating to the pet owner that the tennis ball is no longer helping enhance the oral health of the canine

Embodiments of the present application are directed at a tennis ball for cleaning canine teeth and fighting fetid breath. Embodiments describe a tennis ball coated with a cleaning mixture for cleaning canine teeth and fighting fetid breath. Embodiments herein also describe a process for creating the cleaning mixture and applying the cleaning mixture to the tennis ball.

In another embodiment, the present disclosure relates to a dental spray solution. The dental spray solution may be sprayed directly onto the canines teeth, alleviating some of the concerns with respect to the chew toys discussed above. Once the dental spray solution is sprayed on the canines teeth, the canine may be given a chew toy to assist with scrubbing off stains and tartar. Alternatively, the canine may be given the above disclosed tennis ball after the dental spray solution is applied to assist with scrubbing off stains and tartar.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 depicts a tennis ball coated with a cleaning mixture for cleaning canine teeth and fighting fetid breath.

FIG. 2 depicts a cross section of the tennis ball coated with a cleaning mixture for cleaning canine teeth and fighting fetid breath.

FIG. 3 depicts a process for creating the cleaning mixture and applying the cleaning mixture to the tennis ball.

FIG. 4 depicts a process for cleaning a canine's teeth using a dental spray solution and a chew toy.

### DETAILED DESCRIPTION

Although the techniques introduced above and discussed in detail below may be implemented for a variety of canine toys, the present disclosure will discuss the implementation of these techniques as applied to a tennis ball. The reader will understand that the technology described in the context of a tennis ball could be adapted for use with other canine toys.

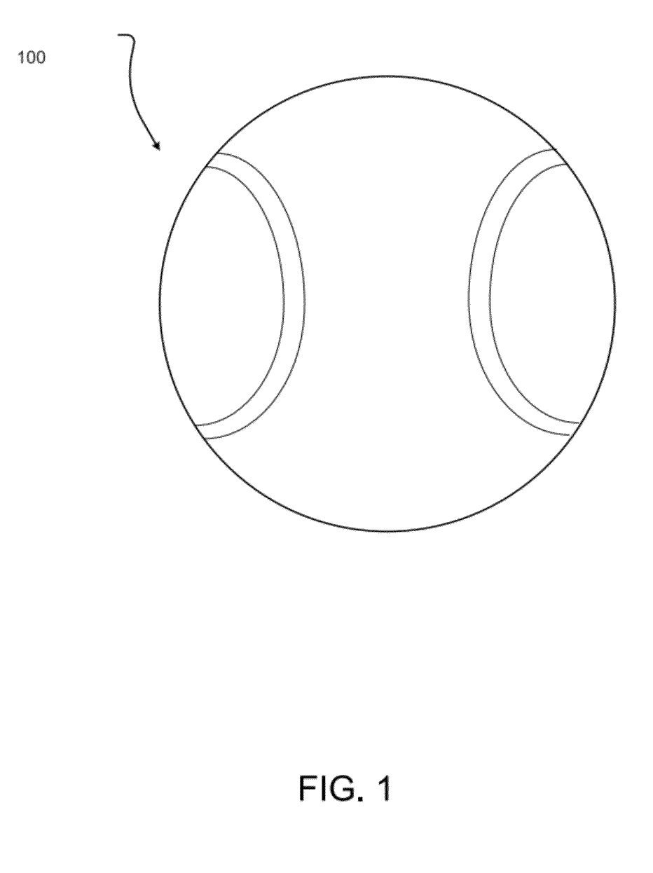

FIG. 1 depicts a tennis ball for cleaning canine teeth and fighting fetid breath as described herein. The tennis ball 100 is coated with a cleaning mixture comprised of sodium lauryl sulfate, Chlorofresh®, and spearmint concentrate. Sodium lauryl sulfate is an anionic surfactant and is particularly useful for removing stains or residues. Its stain-removing attributes have found use in a variety of hygiene products including, but not limited to, toothpaste. Spearmint concentrate is used to fight fetid breath. Spearmint concentrate is extracted from alfalfa leaves and can be used as a mouth wash. Chlorofresh® is used as an attractant in the cleaning mixture. Both the spearmint concentrate and the Chlorofresh® can also be used to reduce digestive tract odors.

By coating the tennis ball 100 with the cleaning mixture as described herein, a canine achieves enhanced oral health benefits by simply playing fetch. The Chlorofresh® in the cleaning mixture attracts the canine to the coated tennis ball. When the canine bites the coated tennis ball 100, the cleaning mixture contacts the teeth and is released into the oral cavity of the canine This contact achieves a three part effect. First, the sodium lauryl sulfate coats the canine's teeth and works to remove stains. Second, the spearmint concentrate fights fetid breath of the canine And third, the spearmint concentrate and Chlorofresh® work to improve the canine's digestive health. This dual effect enables a pet owner to enhance the oral health of the canine without engaging in costly dental cleanings or time consuming, owner implemented tooth brushing sessions.

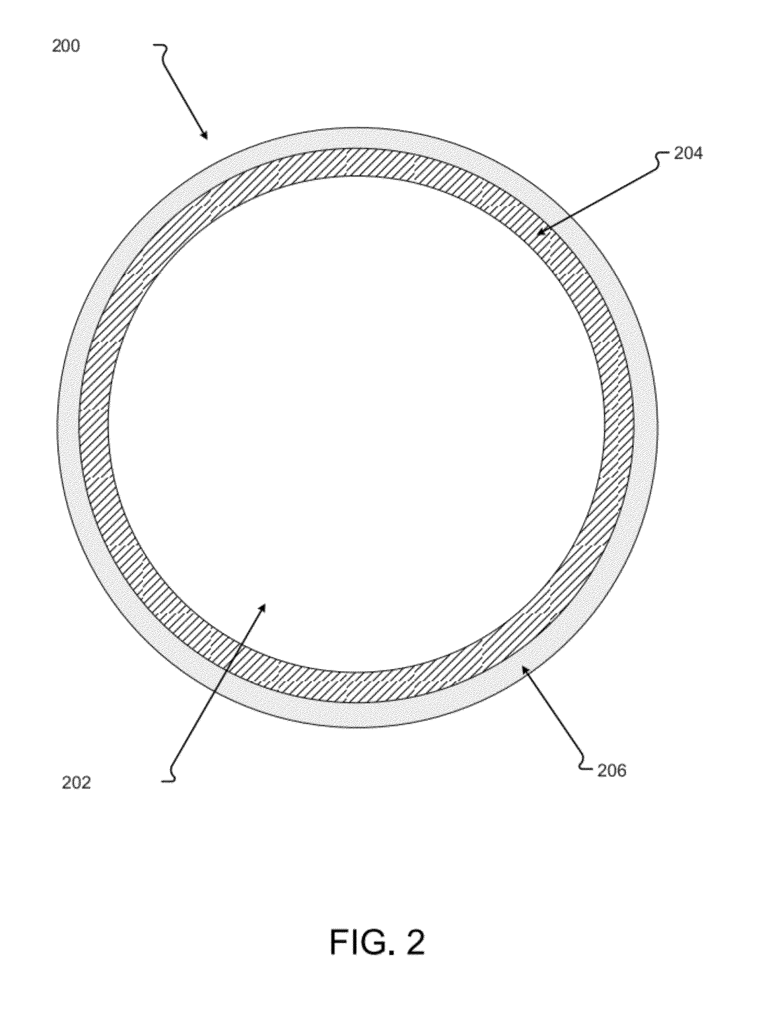

FIG. 2 depicts a cross section of a tennis ball 200 for cleaning canine teeth and fighting fetid breath. As depicted, the tennis ball 200 is covered with a fibrous felt 206 over a hollow rubber layer 204 and filled with air 202. According to embodiments of the present application, the tennis ball 200 is coated with the cleaning mixture 206 discussed above. As shown in FIG. 2, the cleaning mixture 206 is applied to the outside of the tennis ball 200. The cleaning mixture 206 soaks into the felt covering 204 of the tennis ball 200, creating a coat around the surface of the ball.

It is contemplated within the scope of this disclosure that other types of balls with absorbent coverings could be used. Depending on the specifics of the canine, a differently sized ball may be more appropriate than a tennis ball. While an absorbent covering is essential for retention of the cleaning mixture, any absorbent covering on any type of ball is contemplated in accordance with the stated purposes of the present application.

In one embodiment, the cleaning mixture is colored. The colored cleaning mixture works as an indicator to signal when the cleaning mixture needs to be re-applied to the ball. For example, the cleaning mixture could be colored green. The green color of the cleaning mixture would make the ball appear green. As the canine plays with the tennis ball, the cleaning mixture will be removed from the tennis ball as the cleaning mixture is dissolved by the canine's saliva. Once the cleaning mixture is completely removed from the tennis ball, the ball will no longer appear green indicating to the canine's owner that the tennis ball is no longer coated with the cleaning mixture.

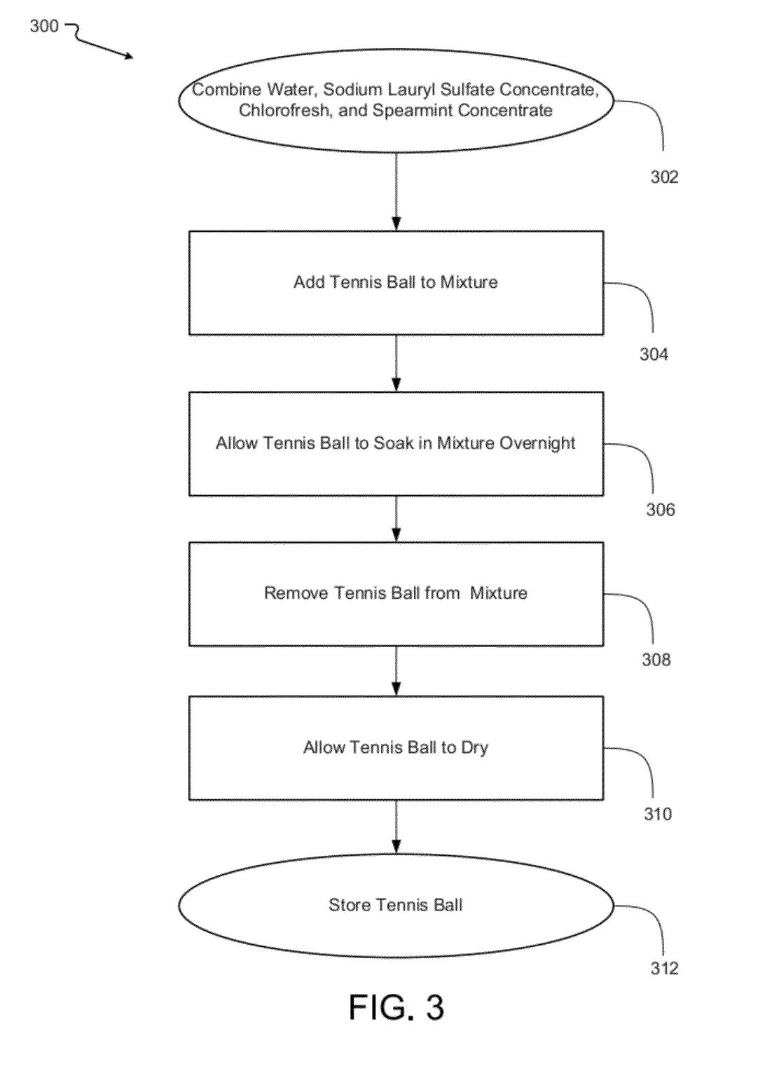

FIG. 3 depicts a process 300 for creating the cleaning mixture and applying the cleaning mixture to the tennis ball as disclosed by the present application. Combine operation 302 combines water, sodium lauryl sulfate concentrate, Chlorofresh®, and spearmint concentrate. In one embodiment, the water, sodium lauryl sulfate concentrate, Chlorofresh®, and spearmint concentrate are combined in a vat. However, any container suitable to hold liquid is contemplated within the scope of this disclosure. The different components can be combined in various proportions. In one embodiment, water constitutes 70 parts of the cleaning mixture, sodium lauryl sulfate concentrate constitutes 5 parts of the cleaning mixture, and Chlorofresh® and spearmint concentrate each constitute 1 part of the cleaning mixture. For example, in 77 milliliters of cleaning mixture, water would constitute 70 ml, sodium lauryl sulfate would constitute 5 ml, and Chlorofresh® and spearmint concentrate each constitute 1 ml of the cleaning mixture.

The combined cleaning mixture is then shaken and/or stirred and preferably mixed throughout.

Add operation 302, one or more tennis balls are added to the cleaning mixture. Any number of tennis balls can be added to the cleaning mixture so long as all the tennis balls are completely immersed. Overcrowding the tennis balls in the container of cleaning mixture may not allow the cleaning mixture to fully coat the tennis balls and decrease its effectiveness.

Soak operation 306, the tennis balls are left in the container to soak for a sufficient period of time. In one embodiment, the balls are allowed to soak for twelve hours. However, different amounts of soak time are contemplated within the scope of this disclosure as long as the soak time is long enough to allow for sufficient “saturation” of the tennis ball with the cleaning mixture.

At remove operation 308, the tennis balls are removed from the container of cleaning mixture. The tennis balls may be removed by hand, utensil, or any other tool for removal known in the art.

At dry operation 310, the tennis balls are allowed to dry. In one embodiment, the tennis balls are allowed to dry for ten hours. However, different dry times are within the scope of the disclosure. Specifically, the tennis ball may take more or less time to dry depending on the temperature of the air, the altitude, etc. In another embodiment, the balls are allowed to drip dry. In one embodiment, the tennis balls are allowed to drip dry. When the tennis balls are allowed to drip dry, they may not be dried entirely, leaving the tennis ball still moist with the cleaning mixture when touched.

At store operation 312, the tennis balls are stored. In one embodiment, the tennis ball is stored in a vacuum sealed bag. By sealing the tennis ball in a vacuum sealed bag, the moisture of the ball after it drips dry will be preserved when the tennis ball is utilized in the future.

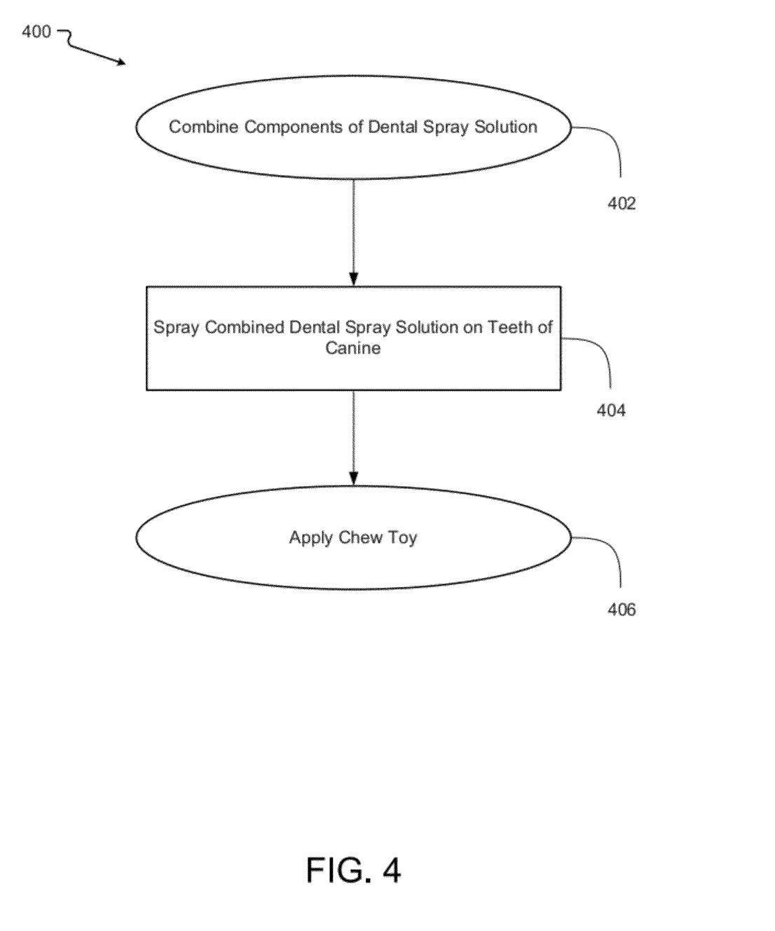

FIG. 4 depicts a process for cleaning a canine's teeth using a dental spray solution and a chew toy. Combine operation 402 combines the components in the dental spray solution. In one embodiment, the ingredients may comprise water, Spearmint Oil, Sodium Lauryl Sulfate, and Chlorofresh®. These components may be combined in an eight ounce spray bottle. However, any container suitable to hold liquid is contemplated within the scope of this disclosure. The different components can be combined in various proportions. In one embodiment, water constitutes 192 parts of the dental spray solution, Spearmint Oil constitutes 1 parts of the dental spray solution, sodium lauryl sulfate concentrate constitutes 16 parts of the dental spray solution, and Chlorofresh® constitutes 8 parts of the dental spray solution. The combined dental spray solution is then shaken and/or stirred and preferably mixed throughout.

Spray operation 404 provides for spraying the combined dental spray solution onto the teeth of the canine The spray solution may be sprayed on all teeth or only a portion of the teeth that need extra cleaning

Apply chew toy operation 406 provides for applying a chew toy the canines teeth. Applying a chew toy may comprise giving the canine a chew toy after the dental spray solution is sprayed on its teeth. In one embodiment, the chew toy may be the soaked tennis ball as described in detail above. Applying the chew toy provides a mechanism to rub the dental spray solution on the canines teeth. Rubbing the dental spray solution increases elimination of plaque and tartar, effectively fighting canine periodontal disease.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. For example, the operations and steps of the embodiments of methods described herein may be combined or the sequence of the operations may be changed while still achieving the goals of the technology. In addition, specific functions and/or actions may also be allocated in such as a way as to be performed by a different method step without deviating from the overall disclosure

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the appended claims.

Unless otherwise indicated, all numbers expressing quantities, properties, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

What is claimed is:

1. A toy for cleaning teeth of a canine, the toy comprising:
a tennis ball; and
a cleaning mixture coated on the tennis ball, the cleaning mixture comprising:
a stain removal agent for removing stains from the canine teeth;
a freshening agent for freshening the breath of the canine; and
an attractant agent for attracting the canine to the tennis ball.

2. The toy of claim 1, wherein the cleaning mixture also includes:
an indicator agent for indicating the presence of the cleaning mixture on the tennis ball.

3. The toy of claim 2, wherein the indicator agent indicates the presence of the cleaning mixture on the tennis ball by displaying a color.

4. The toy of claim 3, wherein the color displayed by the indicator agent is different from the color of the tennis ball.

5. The toy of claim 1, wherein the stain removal agent is sodium lauryl sulfate.

6. The toy of claim 1, wherein the freshening agent is spearmint concentrate.

7. The toy of claim 1, wherein the attractant agent is Chlorofresh®.

8. The toy of claim 1, wherein the freshening agent is further configured to aid in digestion.

9. A cleaning mixture used to clean canine teeth, the cleaning mixture comprising:
a stain removal agent for removing stains from the canine teeth;
a freshening agent for freshening the breath of the canine; and
an attractant agent for attracting the canine

10. The cleaning mixture of claim 9, wherein the cleaning mixture also includes:
an indicator agent for indicating the presence of the cleaning mixture on a tennis ball.

11. The cleaning mixture of claim 10, wherein the indicator agent indicates the presence of the cleaning mixture on the tennis ball by displaying a color.

12. The cleaning mixture of claim 11, wherein the color displayed by the indicator agent is different from the color of the tennis ball.

13. The cleaning mixture of claim 9, wherein the stain removal agent is sodium lauryl sulfate.

14. The cleaning mixture of claim 9, wherein the freshening agent is spearmint concentrate.

15. The cleaning mixture of claim 9, wherein the attractant agent is Chlorofresh®.

16. The cleaning mixture of claim 9, wherein the freshening agent is further configured to aid in digestion.

17. A process for applying a cleaning mixture to a tennis ball for use in canine teeth cleaning, the process consisting of:
combining components to create a cleaning mixture;
adding one or more tennis balls to the cleaning mixture;
soaking the one or more tennis balls in the cleaning mixture for a predetermined period;
removing the one or more tennis balls from the cleaning mixture; and
allowing the one or more tennis balls to dry.

18. The process of claim 17, wherein the combining operation further comprises combining:
a stain removal agent for removing strains from canine teeth,
a freshening agent for freshening canine breath, and
an attractant agent for attracting a canine

19. The process of claim 18, wherein the combining operation further comprises combining an indicator agent, the indicator agent indicating the presence of the cleaning mixture on the tennis ball.

20. The process of claim 17, wherein the soaking operation further comprises soaking the one or more tennis balls in the cleaning mixture overnight.
